(19) United States
(12) Patent Application Publication
(10) Pub. No.: US 2007/0153868 A1
(43) Pub. Date: Jul. 5, 2007

(54) Semiconductor laser

(75) Inventors: Lawrence C. West, San Jose, CA (US); Gregory L. Wojcik, Ben Lomond, CA (US)

Correspondence Address: WILMER CUTLER PICKERING HALE AND DORR LLP, 60 STATE STREET, BOSTON, MA, 02109, US

(73) Assignee: Applied Materials, Inc. Legal Department, Santa Clara, CA (US)

(21) Appl. No.: 11/599,191

(22) Filed: Nov. 14, 2006

Related U.S. Application Data
(60) Provisional application No. 60/736,201, filed on Nov. 14, 2005.

(51) Int. Cl. H01S 3/08

(52) U.S. Cl. 372/92

(57) ABSTRACT

A semiconductor laser having an optical volume of between about 0.1×λ³ to about 30×λ³, where λ is the wavelength of light emitted by the semiconductor laser. The semiconductor laser comprises an optical cavity having a proximal and distal end; a first reflector disposed at the proximal end; a second reflector disposed at the distal end, said optical cavity being defined by the first and second reflectors; an active region disposed transversely with respect to the optical cavity, wherein the semiconductor laser produces an axial emission of light from the distal end of the optical cavity.

This application claims the benefit of U.S. Provisional Application No. 60/736,201, entitled “Semiconductor Laser” filed Nov. 14, 2005.

### CROSS-REFERENCE TO RELATED APPLICATIONS

This application makes reference to U.S. Provisional Patent Application No. 60/736,202, entitled “Pinch Waveguide” filed on Nov. 14, 2005; and U.S. Provisional Patent Application No. 60/736,480, entitled “Semiconductor Device Having A Laterally Injected Active Region” filed on Nov. 14, 2005, both of which are incorporated herein by reference.

### BACKGROUND OF THE INVENTION

1. Field of the Invention

The present invention relates generally to a semiconductor laser, and more particularly to a semiconductor laser which may be utilized in, but not limited to, very large scale integrated optics and optical interconnects.

2. Description of the Prior Art

Two major classes of semiconductor lasers exist, in-plane lasers and Vertical Cavity Surface Emitting Lasers, (hereinafter “VCSELs”). Prior art in-plane lasers utilize waveguides with optical power cross section dimensions larger than a free space wavelength. Laser light is typically emitted from an in-plane laser via an edge of the device, i.e., axial from the active layer and generally in plane with the active layer. Generally, the edge is formed by cleaving the substrate semiconductor wafer. An in-plane laser can also emit from the surface via an angled facet that reflects the beam or grating coupler that diffracts the beam to the vertical emission. In-plane lasers are advantageous for high power lasers and narrow wavelength emissions, which are required, inter alia, for wavelength division multiplexing in fiber transmission. VCSELs, the more recent class of semiconductor lasers, have a lower threshold current for lasing operation than in-plane lasers and emit a vertical round beam of light from either the top or bottom surface of the laser, i.e, transverse to the active layer. VCSELs are advantageous in that the round emission beam may be easily coupled to optical fiber at a low cost.

A major problem with both in-plane lasers and VCSELs is that neither is able to be directly modulated at speeds above tens of gigahertz due to the high capacitance of the active region of the lasers, the inability to run the laser many times threshold due to current and heating, and the method of injecting charge into the active region. The result is that the integration of these lasers to many semiconductor applications is severely limited or otherwise unattainable.

In addition, because VCSELs do not produce in-plane emissions, VCSELs are not readily adaptable for high density horizontal integration in planar devices such as integrated circuits as commonly practiced. Another drawback for VCSELs is that they do not readily dissipate thermal heat. The increased temperature from thermal heat raises the threshold currents, decreases laser efficiency, and reduces integration density. Prior art in-plane lasers, on the other hand, are not readily adaptable for high density horizontal integration due to their relative large size. For instance, in-plane lasers are usually over 100 micrometers in length. Also, in-plane lasers have a high threshold power requirement, which further reduces their integration density.

Recently, a very small semiconductor laser that emits light beams have been created by optical pumping of Photonic Band Gap (PBG) confined lasers. These lasers can be made within an optical volume of less than one cubic wavelength and spatially confined by photonic band gap reflectors. The photonic band-gap reflectors create a very small laser cavity having the active region disposed therein. However, the three-dimensional structures necessary to create the photonic band-gap reflectors are very expensive and very difficult to manufacture with current planar lithographic techniques. By having the active region disposed in the laser cavity, the difficulty of manufacturing this device is significantly increased.

Other in-plane lasers have been made using confinement and feedback from circulation around the edge of small disk of active material supported by a small pedestal at the center, rather than the typical waveguide with mirrors. These disk lasers offer no advantage for power threshold, cannot be electrically pumped in a convenient form, and no convenient method for coupling light to external devices for useful purpose.

### SUMMARY OF THE INVENTION

In general, in one aspect, the invention features a semiconductor laser including: an optical cavity having a proximal and distal end; a first reflector disposed at the proximal end; a second reflector disposed at the distal end, the optical cavity being defined by the first and second reflectors; an active region disposed transversely with respect to the optical cavity, wherein the semiconductor laser produces an axial emission of light from at least the distal end of the optical cavity.

In general, in another aspect, the invention features a semiconductor laser including: means for generating optical gain resulting in generated photons; means for generating optical feedback resulting in modulated emissions of photons; means for confining the generated and emitted photons, wherein the semiconductor laser has an optical volume of between 0.1×λ³ to 30×λ³, wherein λ is the wavelength of light emitted by the semiconductor laser.

In general, in still another aspect, the invention features a semiconductor laser including: a first photon propagating material having a first index of refraction (n1) and having a pinch disposed therein, the pinch having a second index of refraction (n1′); a second photon propagating material disposed below the first photon propagating material and the second photon propagating material having a target region disposed therein and the target region having a third index of refraction (n2); and a photon source for supplying photons to the first photon propagating material, the photon source disposed in the second photon propagating material; wherein n1′<n1, n1′<n2, and the pinch redirects at least a portion of the photons from the first photon propagating material to the second photon propagating material in at least the photon source.

Other objects and features of the present invention will be apparent from the following detailed description of the preferred embodiment.

### BRIEF DESCRIPTION OF THE DRAWINGS

The invention will be described in conjunction with the accompanying drawings, in which:

FIG. 1A is a cross-sectional view of a semiconductor laser which is laterally current injected.

FIG. 1B is a cross-sectional view of a semiconductor laser which is transversely and/or diagonally current injected.

FIG. 2 is a partial top view of the semiconductor laser as illustrated in FIGS. 1A and 1B.

FIG. 3 is a partial side view of the semiconductor laser as illustrated in FIGS. 1A and 1B.

FIG. 4 is a cross-sectional view of the semiconductor laser of FIGS. 1A and 1B illustrating a photon emission from the semiconductor laser.

FIGS. 5A and 5B illustrate end and side views of a particular semiconductor laser which utilizes isolation regions to provide electrical isolation in an active semiconductor laser.

FIGS. 6A through 6D illustrate a laser which also incorporates a pinch in the waveguide.

### DETAILED DESCRIPTION

In order to appreciated the significant improvements over prior art lasers, it would be useful to understand the functioning of a conventional laser. Therefore, we will describe the rudimentary physics associated with conventional lasers, below.

Lasers, in general, and semiconductor lasers, more specifically, may be reduced to one essential and two highly desirable building blocks, mainly: 1) a means for creating an optical emission (essential); 2) a means for providing optical feedback/gain (desirable); and 3) a means for spatially confining light (desirable).

More specifically, to support the emission process in an active layer, a critical number of spontaneously emitting photons are delivered to an optical cavity and a portion are redirected to the active layer. Gain is the process whereby more photons are being emitted than are being absorbed. Optical gain may be provided by electrically stimulating an active region or by pumping the active region with photons, or a combination of the two methods.

The active layer is able to produce photons by providing an active region whereby negatively charged electrons are encouraged to interact with positively charged holes, i.e., electron/hole recombination. The resulting electron/hole interaction emits energy in the form of photons. When the photons being emitted are greater than the photons being absorbed, there is optical gain. The electron/hole interaction is encouraged and controlled by an applied electric field.

Most semiconductor lasers increase electron/hole recombination by injecting electrons at a N-type contact and injecting holes at a P-type contact. The active layer is physically disposed between these contacts. When an electric field is created, i.e., by applying a voltage difference between the N contact and the P contact, the electrons from the N contact and holes from the P contact are pumped into the active region. At this point, the active region contains some electrons and holes. When an electron nears a hole, the electron falls into the hole, i.e., electron/hole pairing, and energy is released in the form of a photon. This is referred to as spontaneous emission.

Without an oversupply of electrons and holes, there is a net absorption, i.e., more photons are absorbed than emitted. In other words, there are more electrons in a lower state. This is referred to as optical loss. The goal, however, is to create enough electron/hole pairs, thereby creating enough photons, to generate an optical gain which is greater than the optical loss.

The photons in the active region are emitted in all directions and are in various modes. The goal is to have a sufficient or critical number of photons to travel in one direction that have the same mode and frequency. This goal is accomplished by the use of mirrors, which may be tuned to a desired frequency. These mirrors are disposed at either end of the optical cavity and reflect back only a fraction of those photons which are oscillating at a desired frequency. The fraction of the spontaneously emitted photons which are naturally traveling in the desired direction and the desired mode is referred to as the Beta. All others photons dissipate or are otherwise absorbed.

The photons are amplified by the reflectors or mirrors. When a photon makes a round trip between the mirrors, it acquires a net round-trip gain. The electron and hole charge density, via increased injected current, is then increased for a until optical gain is greater than the optical loss. In other words, there are more electrons in the active region than there are holes. The optical gain, then, will continue to increase until the active region is transparent, or the total optical gain equals the sum of all sources of optical loss.

Just below the point of transparency, the gain in the optical feedback cavity will increase by stimulated emission of light induced recombination of electrons to holes until the optical gain equals optical loss, and the photons will begin to lase at the desired frequency and mode. This is referred to as the threshold gain. At this current, the losses equal the gain and this is referred to as the threshold current. Above the threshold current, there is a constant and consistent output of photons lasing at the tuned mode, i.e., coherent emission.

The amount of time that it takes to reach the threshold current for a laser with no light in the cavity is directly related to the Beta. Lasers with a low Beta, for example one percent (1.0%) Beta lasers, take a long time to reach threshold. In general, larger lasers have larger active regions. On the other hand, smaller lasers have smaller active regions and, therefore, it does not take as many photons to reach saturation. Thus, the smaller the active region, the faster the device. Therefore, it is desirable to have a high Beta with a small active region.

On the other hand, the size of the active region effects the intensity that may be produced by the laser. Thus, a smaller laser lases quicker but produces a lower intensity. On the other hand, a larger laser will require more time before lasing, but produces a more intense beam.

At the threshold current, lasers are not efficient. The intensity level associated at the threshold current, requires a disproportionate amount of current as compared to a higher level of intensity, which requires just a little more current. The reason for this is that once the threshold point is reached, newly created photons naturally seek the desired mode and the desired direction, this is referred to as stimulated emission. Thus, for just a little more current, the transfer of energy becomes much more efficient, since most if not all newly created photons are going into the correct mode and traveling in the correct direction.

The desired intensity is reached by increasing the input optical gain, via the input current. Accordingly, different intensity levels may be achieved for different applications by adjusting the input current. At some point, however, due to thermal effects, the laser intensity is limited.

The emitted photons in the active region are spatially confined by any number of optical spatial confinement methods, e.g. total internal refraction (TIR), photonic band gaps (PBG), diffraction, gain, and Fresnel refraction. For example, in-plane lasers use TIR for both transverse and lateral confinement via waveguides and Fresnel refraction for confinement in the axial direction, i.e., direction of emission. VCSELs, for example, use gain and diffraction confinement for both transverse and lateral directions, and Bragg diffraction or PBG confinement, in the axial direction.

In a number of described embodiments, a semiconductor laser is provided that includes an optical feedback cavity located within a waveguide and encompassed on both ends by Bragg mirrors and an active region that is located and aligned just below the optical feedback cavity. Directly above the active region, a barrier layer has an index of refraction that is near the indices of both the optical feedback cavity and the active region, thereby creating a least resistance channel. The active region is between N-material and P-material. A voltage differential is provided on the outside surfaces of the N-material and the P-material.

When electrons and holes are injected, optical gain is created in the active region and a fraction of the photons travel through the barrier layer and into the optical feedback cavity. A fraction of the photons now in the optical feedback cavity will then reach one of the two ends of the cavity. A fraction of these photons that reach the end of the optical feedback cavity will encounter a Bragg grating, which will reflect only those photons that are oscillating at the desired frequency. The Bragg grating is tuned to reflect a particular frequency range. When threshold gain is reached, all newly arriving photons from the active region will be aligned or stimulated in direction and mode, thereby creating an amplification. At this point, lasing will occur. A slight addition in gain will produce a large increase in emission intensity, thereby creating an efficient transfer of energy. Prior to threshold, the laser is inefficient, as a greater amount of energy is needed to cause just a small increase in gain.

One particular embodiment is a semiconductor laser including: an optical feedback cavity having a proximal end, a distal end and an optical volume of between about 0.1×λ³ to about 30×λ³, wherein λ is the wavelength of light emitted by said semiconductor laser in free space; a first reflector disposed at said proximal end; a second reflector disposed at said distal end, said optical cavity being defined by said first and second reflectors; an active region disposed laterally with respect to said optical feedback cavity, wherein said semiconductor laser produces an axial emission of said light from said distal end of said optical feedback cavity. In this embodiment, the optical cavity produces a beam emitted in an axial direction and having a modulated threshold emission intensity at a wavelength of light in free space of between about 800 nm to about 2,000 nm when between about 0.01 mA to about 10 mA are provided to inject electrons and holes into the active region, which produce an optical material gain of between about 100 1/cm to about 60,000 1/cm and produces heat of between about 0.01 mW to about 10 mW. The waveguide mode may have a gain less than the material gain as given by the weighted filling factor of the active material in the waveguide mode pattern. Standard filling factors (weighted fraction of beam in gain region) are 4 to 30%, but not limited to this amount.

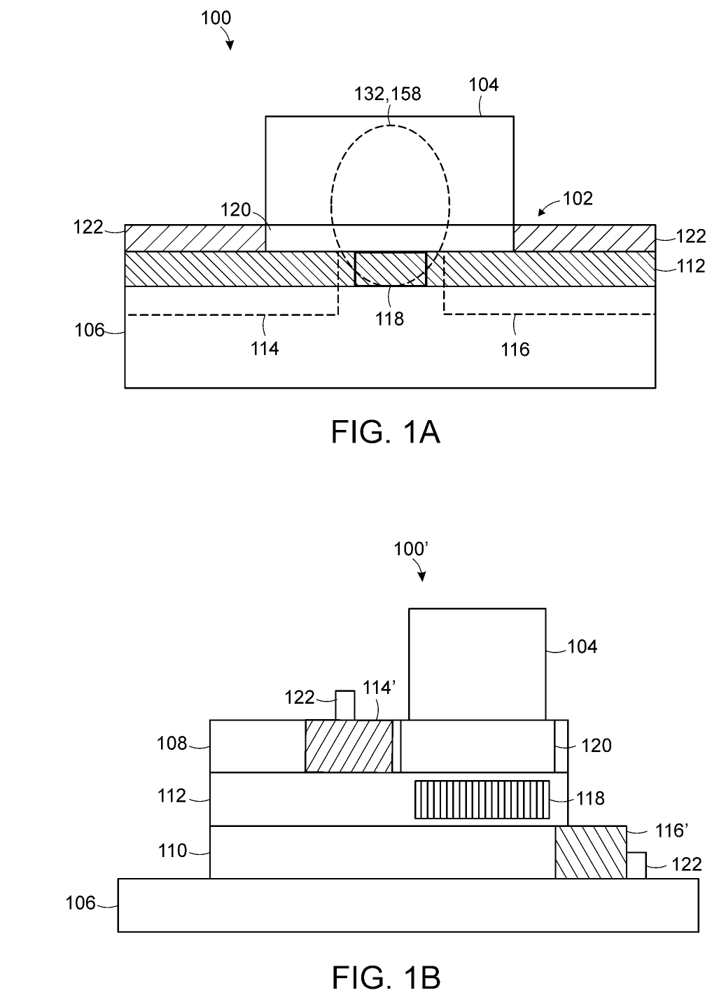

Turning now to FIG. 1, a semiconductor laser structure 100 is illustrated. As may be seen, laser 100 includes an ultra high confinement waveguide 104 made of silicon and a substrate 106. In the described embodiment, substrate 106 is glass (SiO₂) though in general substrate 106 could be formed from a uniform layer of III-V, IV, and/or II-VI semiconductor material selected from the group comprising: GaAs, InP, AlAs, etc, or any combination thereof. For example, if substrate 106 needs to be at least partially optically transparent, then the substrate could be indium phosphide (InP). The index of refraction (n₃) for substrate 106 will typically be between 1.4 and 3.5 and will be between 3.18 and 3.41 when InP is utilized, depending on λ. The material utilized in substrate 106 is selected to provide lattice matching with active layer 112.

It should be appreciated that substrate 106 may be removed. In fact, if substrate 106 is not optically transparent, then it may appropriate to remove substrate 106. This may be accomplished by mechanical polishing, chemical etching, and/or cleaving, or any other method known in the semiconductor material processing art. In the event of removing substrate 106, the protective material would be treated as the substrate.

Ultrahigh confinement waveguide 104 is coupled to a 130 nm active layer 112. In the described embodiment, active layer 112 is formed from a uniform layer of III-V, IV, and/or II-VI semiconductor material selected from the group comprising: GaAs, InP, AlAs, etc., or any combination thereof. Active layer contains an active region 118. Typically, the index of refraction (n₂′.) for active region 118 will be between 3.4 and 3.6 and would preferably be 3.5 while n₂ for active layer 112 will be between 1 and 3.4 It should be appreciated that active layer 112 may be non-uniform with respect to the index of refraction in an axial, lateral, and/or transverse direction outside of active region 118. For example, the index of refraction for active layer 112 may be different in regions outside of active region 118. While no intermediate layers are illustrated between substrate 106 and active layer 112, such intermediate layers could be included.

Waveguide 104 is disposed in a separate layer which is transverse to active layer 112. This feature is unique among edge emitting lasers.

A P-type doped region 114, which acts as a P-type electrode, and an N-type doped region 116, which acts as an N-type electrode, are located on the left and right sides of an active region or target region 118, respectively. Electrons and holes are laterally confined in active region 118 between P-doped region 114 and N-doped region 116. In general, the conductivity type for regions 114 and 116 may be either P or N so long as the two regions have opposite conductivity types. Electrons and holes may be laterally confined by an optional barrier layer 120 and substrate 106 that each have a higher bandgap than active region 118, so the electron and hole charge carriers will fall into and stay in active layer 112. Photons are emitted in region 132. While waveguide 104 is described as being constructed of silicon, it may be constructed of any semiconductor material so long as it has a higher bandgap than active layer 112. Isolation between devices 100 may be provided by air gaps which are preferably created by etching. This isolation provides the stand alone area associated with each laser 100, 100′. These air gaps may be re-grown or filled with a material have poor electrical conductivity properties.

In the described embodiment, doping of the P-type doped region 114 and the N-type doped region 116 is preferably performed by ion implanting with masks rather than incorporation during growth. However, a broad low-level P-type doping may be made in the active layer to assist in carrier transport and laser operation. The N-type ion implantation is typically made at a concentration that is many times higher than the low level P-type doping in order that the net reduction in free electron charge in the N-type region is kept to a minimum.

High levels of ion implanting may cause the active layer to disorder but they may assist with optical confinement of the device. High quality quantum wells are not essential for good optical properties in the electrode region, i.e., outside of the active region.

The extra axial length of the quantum wells provided by using laterally oriented electrodes provides extra area for carrier capture and a greater region for electron energy to dissipate for lower electron temperatures and higher speed.

The parasitic capacitance between the N and P type materials is reduced and current spread is greatly reduced, even to near zero, in a laser structure such as shown in FIG. 1A. Parasitic capacitance is defined as the stored charge divided by the applied voltage. Current spread refers to electrons spreading out from the desired active region.

An important consideration in making a laser such as shown in FIG. 1A is how far the implanted donor and acceptors diffuse. In a shallow doping, with a peak doping about 70 nm deep at the interface between the ohmic contact and the quantum well, the lateral spread during implant will generally be low. Therefore, lateral diffusion during annealing of the quantum well structure may be important. However, the amount of lateral diffusion may be determined by one mask with multiple lithographic separations between N-type and P-type regions, and repeated anneal cycles until the performance of the quantum well structure is optimized.

Turning now to FIG. 1B, a non-laterally, i.e., transversely or diagonally, injected semiconductor laser 100′ is illustrated. Active region 118 is located within active layer 112. Isolation between devices may be provided by air gaps which are typically created by etching. These air gaps may be re-grown or filled with a material having poor electrical conductivity properties. A first semiconductor layer 108 is provided that has at least a region 114′ which is doped with a P-type material. Layer 108 is disposed above active layer 112. A second semiconductor layer 110 is provided that has at least a region 116′ which is doped with an N-type material. Layer 110 is disposed below active layer 112. In addition, semiconductor layer 108 may include an optional barrier layer 120 disposed above active region 118. Barrier layer 120 provides electrical isolation and is optically transparent to active region 118. Barrier layer may include one or more oxidized layers. Waveguide 104 is disposed above layer 108 and is aligned with active region 118. An electrode 122 is disposed above P type region 114′ as well as by N type region 116′. Electrodes 122 may be an Ohmic, Schottky, or any other contact known in the electrical arts. A voltage source (not shown) is connected to at least one electrode 122 is provided to inject current into active region 118.

The particular lateral and transverse locations for regions 114′ and 116′ are merely illustrative of one method of forming electrical contacts in a semiconductor laser. The distinction between laser 100 and laser 100′ is that of lateral injection of the active region in the same layer as the active region is disposed. Thus, laser 100′ is illustrative of non-lateral injection where the injection takes place in a layer other than the layer containing the active region. Laser 100 is illustrative of a semiconductor laser that utilizes lateral injection of electrons. These electrons will be “cool electrons” as discussed in U.S. Provisional Patent Application No. (T.B.D.), entitled “Semiconductor Device Having A Laterally Injected Active Region” filed on Nov. 14, 2005, the contents of which are incorporated herein by reference.

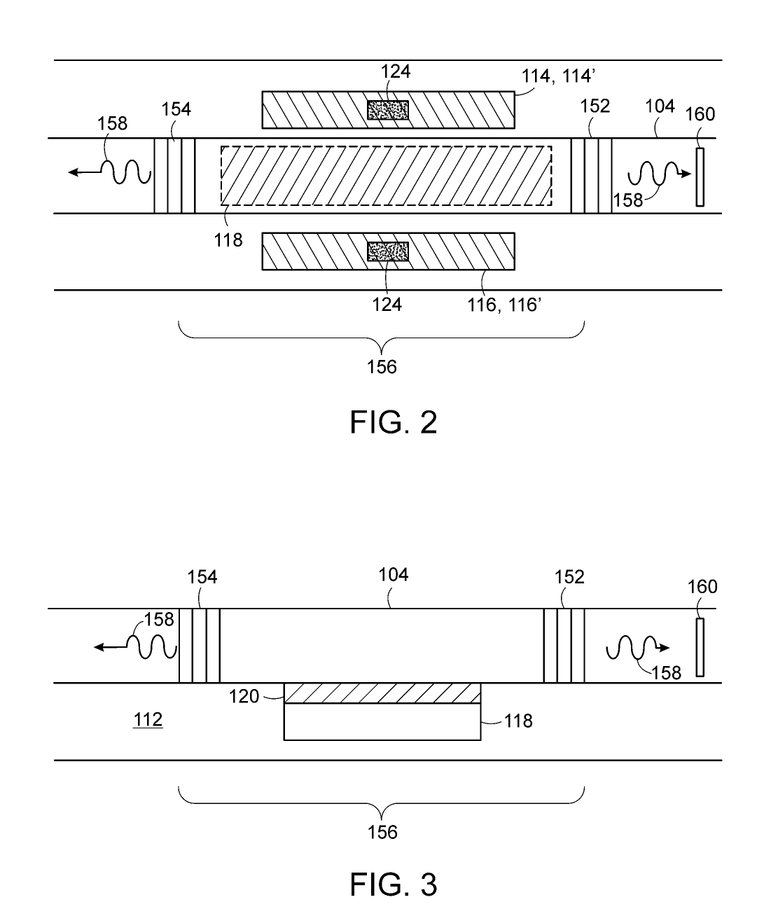

Turning now to FIG. 2, a simplified top view of semiconductor laser 100,100′ is provided. As may be seen, reflectors 152 and 154 are disposed at axial ends of active region 118 and in ultra high confinement waveguide 104. In the described embodiment, reflectors 152 and 154 are mirrors and in particular, DBR mirrors. However, other types of reflectors may be utilized. Examples of mirrors or reflectors include, but are not limited to Distributed Bragg Gratings (DBG's), Photonic Band Gap (PBG) devices, refractive means such as total internal reflection from angled surfaces partial reflection from surfaces of differing refractive index (Fresnel Refraction), and metallic surface reflection. In certain embodiments, it is desirable that reflectors 152 has between 75 and 95 percent reflection while reflector 154 has between 75 and 95 percent reflection.

Reflectors 152 and 154 define the axial extent of optical cavity 156. In a preferred embodiment, optical cavity 156 has width of between about 0.25λ and about 1.9λ; and length of between about 5 microns and about 200 microns.

While reflectors 152 and 154 have been illustrated as being similar, they may be substantially different from each other. If fact, depending on the particular application for laser 100,100′, it may be advantageous to have reflectors 152, 154 having different properties. Any further discussion of these reflectors will assume that they are similar and only the transmission characteristics of the reflectors 152,154 are varied.

As discussed above, a certain percentage of the photons inside optical cavity 156 will resonate between reflectors 152 and 154. Only those photons 158 that are traveling in the correct direction and only those photons which are oscillating at the mode those mirrors are transmitted past reflector 152 or 154. The reflectors serve a two fold purpose. The reflectors 152 and 154 are tuned to a particular frequency or mode so that they will only reflect most of those photons which are oscillating at that chosen frequency and second, the reflectors, by transmitting or scattering all other photons, create a resonating or amplification effect of the desired frequency.

In the described embodiment, optical cavity 158 produces a beam emitted in an axial direction and having a modulated threshold emission intensity at a wavelength of light in free space of between about 800 nm to about 2,000 nm when between about 0.01 mA to about 10 mA are provided to inject electrons and holes into the active region, which produce an optical material gain of between about 100 1/cm to about 60,000 1/cm and produces heat of between about 0.01 mW to about 10 mW. The waveguide mode may have a gain less than the material gain as given by the weighted filling factor of the active material in the waveguide mode pattern. In the described embodiment, standard filling factors (weighted fraction of beam in gain region) are in the range of 4 to 30%, but they are not limited to this amount.

In the described embodiment, optical cavity 156 has the same material and dimensional design as waveguide 104. Accordingly, the lased photons 158 that emit from reflectors 152,154 are seamlessly and efficiently coupled to waveguide 104. However, the shape of optical cavity 156 may be manipulated to produce many different intensity output shapes.

Photons 158 are emitted into UHC waveguide 104. For a detailed discussion of waveguide 104, the reader is referred to U.S. Pat. No. 6,051,445, entitled “Techniques for Forming Optical Electronic Integrated Circuits Having Interconnects in the Form of Semiconductor Waveguides,” the contents of which are incorporated herein by reference. Waveguide may be made from any material that is capable of guiding photons. For example, waveguide 104 can be formed from a uniform layer of III-V, IV, and/or II-VI semiconductor material selected from the group comprising: Si, GaAs, InP, AlAs, etc., or any combination thereof. Typically, waveguide 104 should be at least partially optically transparent. It may also be multimode or single mode. In addition, the index of refraction (n₁) for waveguide 104 will typically be between 3.4 and 3.6, e.g. about 3.49. Confinement layer 122 may be non-uniform with respect to the index of refraction in an axial, lateral, and/or transverse direction.

In the described embodiment, waveguide 104 has a width of between about 0.25λ and about 1.9λ and an index of refraction of between 3 and 4.

Waveguide 104 may be maintained in free space or may be enclosed in a protective material such as glass (SiO₂). The enclosing material or free space will have an effective index of refraction of n₀. In the described embodiment, n₁ is greater than n₀, e.g. n₁ is 2 times n₀.

Photons 158 are emitted in an axial direction, with respect to active region 118 and in a plane substantially parallel to active region 118. This method of emission allows separation of active region 118 from waveguide 104 and is different from all known prior art edge emitters. Semiconductor laser 100,100′ is also different from surface emitters in that photons leaving optical cavity 156 are not oriented in the transverse direction with respect to active region 118. By coupling waveguide 104 and respective optical cavity in a layer that is substantially parallel to active region 118, one is able to obtain a very small edge emitting laser. This feature is illustrated in FIG. 3. Thus, one is able to overcome the shortcomings of prior art edge emitters and allow for high density integration of lasers 100, 100′ in devices.

Once a critical number of photons are oscillating in optical cavity 156, i.e., optical gain is greater than optical loss, all newly arriving photons will match up in direction and mode, thereby creating an amplification effect and, ergo, lasing. At this point the threshold gain is realized and a constant and consistent output of photons 158 will lase at the tuned mode.

The laser beam 158 may be generated in two directions, axially along the path of waveguide 104. Depending on the reflectiveness of reflector 152 and reflector 154, light will either be reflected back into optical cavity 156 or escape optical cavity 156 and propagate down waveguide 104. The device can be configured so that photons 158 will propagate in one direction. Or alternatively, it can be configured so that photons 158 may simultaneously propagate in both directions, i.e., through both reflector 152 and reflector 154.

Semiconductor laser 100,100′ may be optically, i.e., spatially, confined by any of the known confinement techniques and more specifically, by any combination of gain, total internal reflection, diffraction, or dielectric changes.

As may be seen, P type region 114 may be laterally disposed with respect to active region 118 as illustrated in FIGS. 1B and 2. In a similar manner, N type region 116 may be laterally disposed on the other side of active region 118.

The P-type region 114, 114′ may be a material such as a semiconductor material, discussed above, and doped with a dopant such as, but not limited to: Be, Zn, Mg, Cd, etc. In the described embodiment, P-type region 114, 114′ is either doped with Be or Zn (e.g. Zn having a concentration of between 5×10¹⁸ to 1×10²⁰. The electrode 124, associated with region 114,114′ typically will have a lateral dimension of between approximately of 200 nm to 1 micron.

The N-type region 116, 116′ may be a material such as a semiconductor material, discussed above, and doped with a dopant such as, but not limited to: Si, Se, Te, Sn, Cr, etc. For example, N-type region 116, 116′ may be Si or Sc and having a concentration of between about 5×10¹⁸ to 1×10²⁰. Typically, the electrode 124 associated with region 116, 116′ has a lateral dimension that is in the range of approximately 200 nm to 1 micron.

In the described embodiment, waveguide 104 has a substantially constant lateral dimension. Alternatively, waveguide 104 may have an optical cavity 156 that is laterally pinched to more readily coax the photons from active region into optical cavity 156 or to optically pump active region 118. The term “pinch” refers to a region of a waveguide in which the cross-section of the waveguide is reduced in the lateral direction with respect to at least one other region of the waveguide. This lateral pinch is referred to as a Dagger and is described in U.S. Provisional Patent Application No. (TBD), entitled “Pinch Waveguide” filed on Nov. 14, 2005.

Active layer 112 and/or active region 118 may be formed by growing a quantum well structure on substrate 106. Active layer 112 and/or active region 118 is made up of a III-V, IV, and/or II-VI compound, or combinations thereof. Specific examples of III-V semiconductor materials include AlₓGa₁₋ₓAs and In₁₋ₓGaₓAs_{y}P_{1-y}, where x varies between 0 to 1 and y varies between 0 to 1. The semiconductor material may include other atomic material(s) such as nitrogen. When a semiconductor material is utilized in a layer, that layer may be an unstrained layer or a compressive or tensile strained layer. Alternatively, active layer 112 and/or active region 118 can be formed from InGaAlAs, GaAs, and/or AlGaAs. In the described embodiment, active region 118 has a width of between about 200 nm and about 1 micron, a height of between about 15 nm and about 500 nm, and a length at or shorter than the optical cavity.

Semiconductor laser 100,100′ has other advantages and distinguishing characteristics over prior art devices. We will briefly discuss some of these next.

Once the threshold current is realized, the intensity of the generated laser beam 158 may be increased by increasing the input current. Semiconductor laser 100,100′ uses an input current of between 0.01 mA to 1 mA to produces a threshold emission intensity of between about 0.01 mW to 10 mW.

Semiconductor laser 100,100′ has a capacitance of between about 0.05 fF to about 10 fF. Prior art devices typically have much higher capacitances and thus are less desirable in very lager scale integrated circuits.

In one embodiment, semiconductor laser 100,100′ has a threshold current of about 10 micro amps. This very low current demand results in a very low heat production, and thus, less heat needs to be dissipated. This is a highly desired result. The optical cavity produces a beam emitted in an axial direction and having a modulated threshold emission intensity at a wavelength of light in free space of between about 800 nm to about 2,000 nm when between about 0.01 mA to about 10 mA are provided to inject electrons and holes into the active region, which produce an optical material gain of between about 100 1/cm to about 60,000 1/cm and produces heat of between about 0.01 mW to about 10 mW. Thus, the efficiency of the device may be approximately 50%. The waveguide mode may have a gain less than the material gain as given by the weighted filling factor of the active material in the waveguide mode pattern. Standard filling factors (weighted fraction of beam in gain region) are 4 to 30%, but are not limited to this amount.

Semiconductor laser 100,100′ has at least three schemes of operation. In a first scheme of operation, the laser is in an off state. In a second scheme, laser 100,100′ is operating at threshold intensity. And in a third scheme, the laser is operating somewhere between threshold intensity and maximum intensity. In addition, the semiconductor laser may be initiated from either a cold start or from a threshold start.

In a cold start, semiconductor laser 100,110′ must rely on current gain to achieve threshold gain. But, in a threshold start, laser 100,110′ is already at threshold gain. Accordingly, a slight increase in current will cause semiconductor laser 100,110′ to increase the emission intensity from anywhere between threshold intensity to the maximum intensity.

Semiconductor laser 100,100′ may have a stand-alone area of as small as between about 20 square microns and 1,000 square microns. Such a small area allows for much improved density over prior art devices.

Any of the known or a combination of any of the known optical spatial confinement methods, such as confinement by photonic band gaps, gain, total internal reflection (i.e., refraction), diffraction, or dielectric changes may be used to confine or otherwise guide the light or photons.

Turning now to FIG. 3, an axial cross section of semiconductor laser 100,100′ is illustrated. Active region 118 is disposed in active layer 112. Optional electrical isolation layer 120 may be disposed above active region 118 to provide electrical channeling in the device. UHC waveguide 104 is disposed in a plane above and parallel to active region 118. An optical cavity 156 is formed by reflectors 152 and 154 which are disposed in waveguide 104. A resonator is formed by active region 118 and optical cavity 156. An optional coupling means 160 is provided for coupling photons 158 to a layer above waveguide 104. However, coupler 160 is not required for the functioning of semiconductor laser 100,100′.

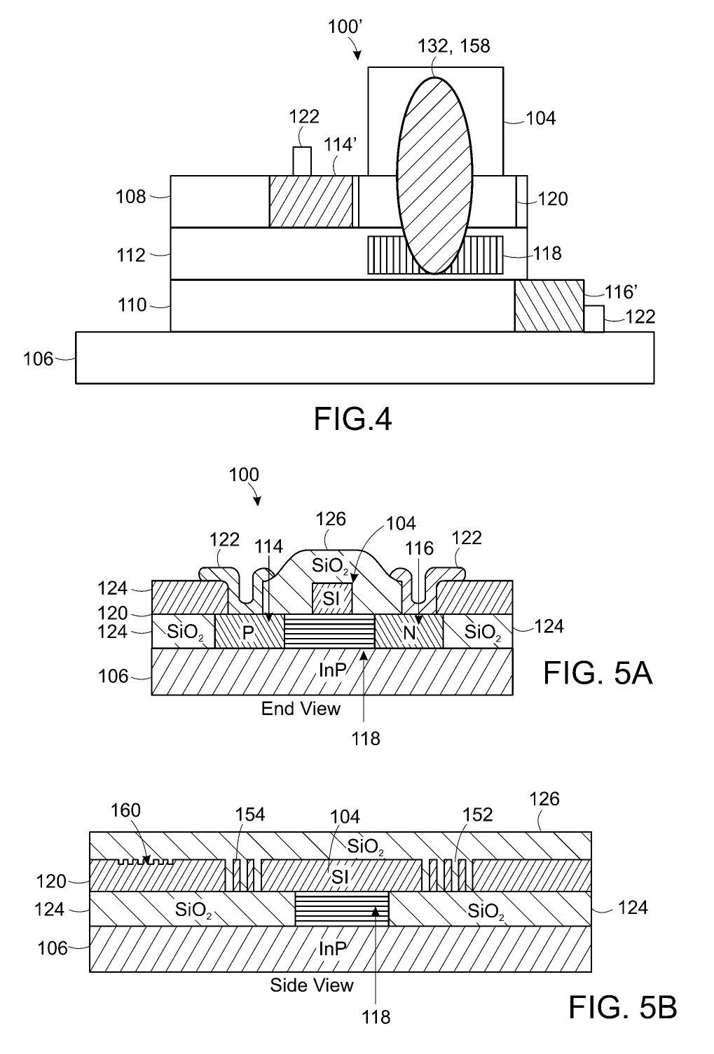

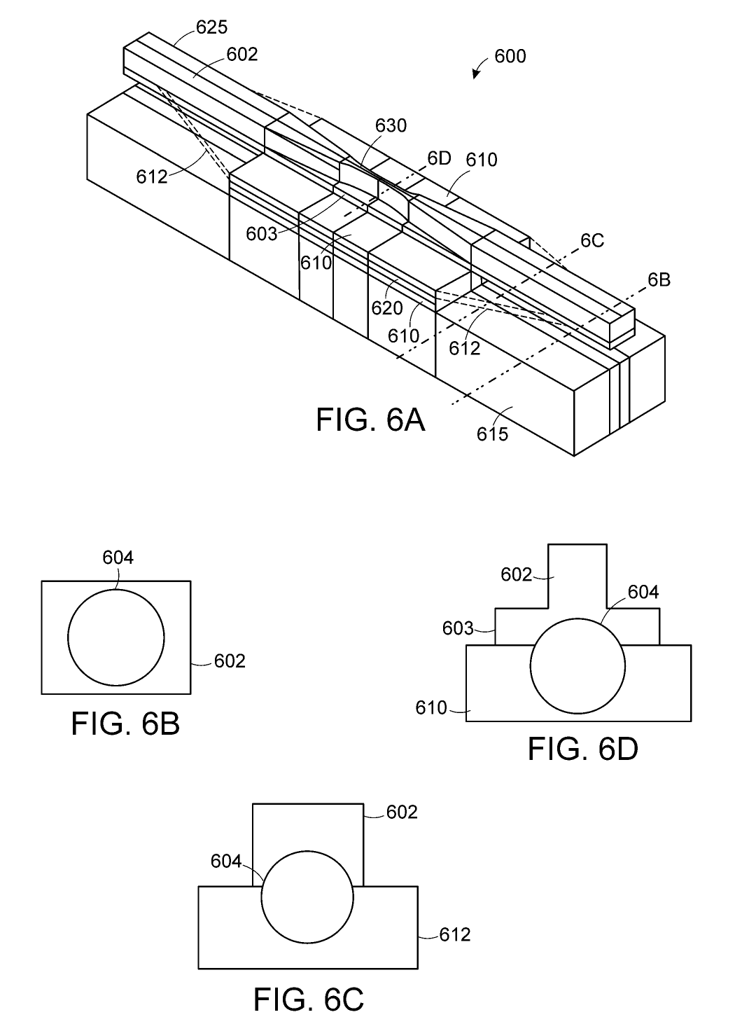

Turning now to FIG. 4 and FIG. 1A, the photon emission region 132 for semiconductor laser 100,100′ is illustrated. As may be seen, the emission region 132 is in at least waveguide 104. It should be appreciated that the emission region is illustrated after the photons 158 have been generated and before mirror 152. These views show the details of semiconductor laser 100,100′ at the axial location downstream of mirror 152. This feature is also illustrated in FIGS. 6A through 6D. In the described embodiment, emission 132 has a round shape upon exiting waveguide 104, though other emission shapes are possible. For a full discussion of the propagation of the emission region in waveguide 104, the reader is referred to co-pending U.S. Provisional Patent Application No. (T.B.D.), entitled “Pinch Waveguide” filed on Nov. 14, 2005, the contents of which are incorporated herein by reference.

Examples will now be described.

### EXAMPLE I

Turning now to FIGS. 5A and 5B, an end and side view of semiconductor laser 100 are respectively illustrated. Laser 100 includes an ultra high confinement waveguide 104 made of silicon and a substrate 106. Substrate 106 is made of indium phosphide (InP) which is at least partially optically transparent. The index of refraction (n₃) for substrate 106 is between 3.18 and 3.41, depending on λ. The material utilized in substrate 106 is selected to provide lattice matching with active region 118.

Active layer contains an active region 118. The index of refraction (n₂′.) for active region 118 will be between 3.4 and 3.6 (e.g. 3.5). While no intermediate layers are illustrated between substrate 106 and active region 118, intermediate layers may be included.

Waveguide 104 is disposed in a separate layer which is transverse to active region 118.

A P-type doped region 114, which acts as a P-type electrode, and N-type doped region 116, which acts as an N-type electrode, are located on the left and right side of an active region or target region 118, respectively. Electrons and holes (not shown) are laterally confined in active region 118 between P-doped region 114 and N-doped region 116. The conductivity type for regions 114 and 116 may be either P or N so long as the two regions have opposite conductivity types. Electrons and holes may be laterally confined by a barrier layer 120 and substrate 106 that each have a higher bandgap than active region 118, so the electron and hole charge carriers will fall into and stay in active layer 112. Photons are emitted into waveguide 104. Both electrical and optical isolation between devices 100 may be provided by glass regions 124. This isolation is needed to provide the stand alone area associated with each laser 100, 100′. A cladding 126, also of glass, is disposed along waveguide 104 to protect waveguide 104 and to assist in optical confinement in waveguide 104. Cladding 126 and isolation means 124 are of the same material, i.e., SiO₂.

Doping of the P-type doped region 114 and the N-type doped region 116 is performed by ion implanting with masks rather than by incorporation during growth. However, a broad low-level P-type doping may be made in the active layer to assist in carrier transport and laser operation. The N-type ion implantation is made at a concentration that is many times higher than the low level P-type doping in order that the net reduction in free electron charge in the N-type region is kept to a minimum.

The parasitic capacitance between the N and P type materials is reduced and current spread is greatly reduced, even to near zero, in a laser structure such as shown in FIGS. 5A and 5B. Parasitic capacitance is defined as the stored charge divided by the applied voltage. Current spread refers to electrons spreading out from the desired active region.

### EXAMPLE II

FIGS. 6A, 6B, 6C, and 6D illustrate a waveguide 600. It includes confinement layer or UHC Waveguide 602 disposed directly on top dielectric layer 610 and having substrate 615 disposed below bottom dielectric layer 610. As may be seen, top dielectric layer 610 may have optional pinches 612 and thus form a double dagger with respect to confinement layer 602. Between dielectric layers 610 is active layer 620. Confinement layer 602 has a region 625 that has a substantially uniform transverse cross-section. Confinement layer 602 also has a pinch 630 that redirects photons in a direction of the low velocity channel. Section 603 is a transverse portion confinement layer 602 which is not pinched in a lateral direction in pinch 630. This is illustrated in FIG. 6D and will be discussed in detail below.

The term “low velocity channel” refers to channeling photons in a direction associated with materials having a higher index of refraction. The effective index of refraction of a material indicates how fast an optical mode will propagate in that material, i.e., the material will slow the optical mode by a certain factor. Accordingly, by utilizing materials having a higher index of refraction in combination with materials having lower index of refraction, one may channel photons in a particular direction, e.g., axially, laterally, and/or transversely.

Turning now to FIG. 6D, a description of the photons propagating along the longitudinal axis of waveguide 600 will be described. As may be seen, in FIG. 6B, the photons and respective energy, illustrated by ring 604 is encapsulated by confinement layer 602. As the photons propagate axially down waveguide 600, optional pinch 612 begins to pull the photons into pinch 612 due to the close index of refraction between layers 602 and 610. While pinch 612 is illustrated as being as wide (at its widest point) as layer 610, pinch 612 may be as wide as layer 610 or as narrow as region 625. As may be seen in FIG. 6C, photons and respective energy, illustrated by ring 604 are now disposed both in layer 602 and pinch region 612. This produces direct coupling of the photons between these two layers. This is accomplished by physical contact between the two layers and the close indicies of refraction of these two layers as discussed above, i.e., both layers are part of the low velocity channel for some portion of pinch 612. This is in direct contrast to prior art devices that utilize evanescent waves to couple two waveguides such as in the case of delta/beta couplers. Evanescence relies on the coupling of the non-propagating or static optical field disposed outside of the waveguides. Other prior art devices which use evanescence include those taught by Takeuchi et al. in the article entitled “A high-power and high-efficiency photodiode with an evanescently coupled graded-index waveguide for 40 Gb/s applications” and Demiguel et al. in an article entitled “Low-cost, polarization insensitive photodiodes integrating spot size converters for 40 Gb/s applications.” Direct coupling and evanescence are two discrete concepts that are distinctly different in approach and application.

As the photons continue to propagate axially down waveguide 600, pinch 630 begins to push the photons into layer 610 due to the close indicies of refraction between layers 630 and 610. As may be seen in FIG. 6D, photons and respective energy, illustrated by ring 604 are now disposed both in layer 610 and section 603. Not all photons are redirected due to interaction with the pinch. Some photons continue to propagate along the longitudinal axis of waveguide 600 in section 603. By not providing a taper in section 603 an unexpected result is achieved with regard to lateral confinement of the photons, i.e., the photons are strongly laterally confined as they propagate axially. This is illustrated by ring 604. This is a highly desired result which prevents optical spread of the beam in a lateral direction.

Photons may be made to contact a laser diode either by redirecting photons from a waveguide via interaction with a pinch, or by directing photons that continue to propagate along the longitudinal axis of the waveguide in region 603 into a laser diode or photon source. When contacting the laser diode or photon source, the photons are at or below a threshold level such that the photons will not cause the laser diode or photon source to lase. However, contacting a laser diode or photon source with this level of photons greatly decreases the amount of time necessary for the laser diode or photon source to overcome the threshold such that the laser diode or photon source will lase. Thus, by controlling the level of photons contacting the laser diode or photon source, the laser diode or photon source may be maintained in a state of readiness.

A double pinch may be used to control the level of photons entering a laser diode. Photons interacting with a pinch will be redirected at a degree that is dependent upon the magnitude of the pinch and the difference between the effective indices of refraction. Thus, based on the present disclosure, one of ordinary skill in the art could fabricate a variety of pinch waveguides with pinches of varying magnitudes, thicknesses, and/or materials to meet the requirements of particular applications. Having an axially disposed double pinch waveguide, a controlled and predetermined level of photons is allowed to continue along the longitudinal axis of the waveguide to interact with the second pinch. The same degree of control may be exercised at the second pinch, i.e., managing the photons that are redirected and the photons that continue propagating in the waveguide. The waveguide may be fabricated with any number of pinches in any configuration depending on the desired application.

Photon redirection may also be controlled by methods, such as layer doping and cladding. For example, the waveguide, including the pinch, may be clad with any suitable cladding material, such as glass, silicon oxynitride or a polymer, to confine photons within the waveguide. The various layers of the OEIC may be doped to achieve the desired indices of refraction for each layer.

Redirected photons may be directed to any suitable device or layer. For example, photons may be redirected to another waveguide. Redirected photons may also be redirected into a target region. In addition, the target region may be active layer 620. The target region or active layer may, for example, contain a photodiode (photon detector) that interacts with photons to produce current or may be a laser (photon source) and thus form an optical amplifier. The target region or active layer may contain a variety of optoelectronic devices, logic devices, etc.

The semiconductor laser may be used for semiconductor logic. For example, a high emission intensity may be associated with a logic 1 and a low emission intensity would be associated with a logic 0. The semiconductor laser in conjunction may then be used to facilitate opto-electronic logic. The waveguide used to connect the logic gates. A benefit of using the semiconductor laser described herein over using conventional lasers is that the cycle time from logic 0 to logic 1 and back is shorter than it is for existing electronic logic using wires.

Note that the term “semiconductor material” as used herein means any III-V, IV and/or II-VI compound from the periodic table, or combination thereof. Specific examples of III-V semiconductor materials include AlₓGa₁₋ₓAs and In₁₋ₓGaₓAs_{y}P_{1-y}, where x varies between 0 to 1 and y varies between 0 to 1. The semiconductor material may include other atomic material such as nitrogen without departing from the present definition. When a semiconductor material is utilized in a layer, that layer may be an unstrained layer or a compressive or tensile strained layer.

Other embodiments are within the following claims.

What is claimed is:

1. A semiconductor laser comprising:
an optical cavity having a proximal and distal end;
a first reflector disposed at said proximal end;
a second reflector disposed at said distal end, said optical cavity being defined by said first and second reflectors;
an active region disposed transversely with respect to said optical cavity, wherein said semiconductor laser produces an axial emission of light from at least said distal end of said optical cavity.

2. The semiconductor laser of claim 1, wherein said semiconductor laser is capable of being modulated.

3. The semiconductor laser of claim 1, wherein said axial emission of light has a wavelength (λ) from between 800 nm to 2,000 nm.

4. The semiconductor laser of claim 1, wherein said active region comprises III-V, IV, and/or II-VI semiconductor material.

5. The semiconductor laser of claim 1, wherein said semiconductor laser has an optical volume of between 0.1×λ³ to 30×λ³.

6. The semiconductor laser of claim 1, wherein said photons in the optical cavity are confined by total internal reflection.

7. The semiconductor laser of claim 1, wherein threshold power is between 0.01 mW to 10 mW.

8. The semiconductor laser of claim 7, wherein said threshold requires an input voltage of between 0.7V to 1.5V.

9. The semiconductor laser of claim 1, wherein a nominal operating point is between 1 and 5 times threshold.

10. The semiconductor laser of claim 9, wherein said nominal operating point requires an input voltage of between 0.7V to 1.5V.

11. The semiconductor laser of claim 7, wherein said threshold requires an input current between 0.01 mA and 1 mA.

12. The semiconductor laser of claim 9, wherein said threshold requires an input voltage of between 0.7V to 1.5V and an input current between 0.02 mA and 10 mA.

13. The semiconductor laser of claim 1, wherein said emission is a substantially round beam.

14. The semiconductor laser of claim 1, wherein said emission shape is a function of the shape of said optical cavity.

15. The semiconductor laser of claim 1, wherein said active region is disposed in a layer parallel to and below said optical cavity.

16. The semiconductor laser of claim 1, wherein said semiconductor laser produces heat of between 0.01 mW to 10 mW for an intensity of between 0.01 mW to 10 mW.

17. The semiconductor laser of claim 1, wherein said semiconductor laser has an efficiency of 50%.

18. The semiconductor laser of claim 1, wherein said semiconductor laser has an efficiency of between 25% and 50%.

19. The semiconductor laser of claim 1, wherein said emission is seamlessly integrated into a waveguide.

20. The semiconductor laser of claim 19, wherein said optical cavity receives photons via said waveguide.

21. The semiconductor laser of claim 1, wherein said optical cavity has a width between 0.25λ and 1.9λ, where λ is the wavelength of said axial emission of light.

22. The semiconductor laser of claim 1, wherein said optical cavity has a length between 5 microns and 200 microns.

23. The semiconductor laser of claim 1, wherein said laser is located on the same planar material with other semiconductor devices.

24. A semiconductor laser comprising:
means for generating optical gain resulting in generated photons;
means for generating optical feedback resulting in modulated emissions of photons;
means for confining the generated and emitted photons, wherein said semiconductor laser has an optical volume of between 0.1×λ³ to 30×λ³, wherein λ is the wavelength of light emitted by said semiconductor laser.

25. The semiconductor laser of claim 24, wherein said means for generating optical gain comprises electrical pumping.

26. The semiconductor laser of claim 24, wherein said means for generating optical gain comprises photon pumping.

27. The semiconductor laser of claim 24, wherein said means for generating optical gain comprises a combination of electrical pumping and photon pumping.

28. The semiconductor laser of claim 24, wherein said means for generating optical feedback comprises at least one reflector.

29. The semiconductor laser of claim 24, wherein said means for generating optical feedback comprises at least one resonator.

30. The semiconductor laser of claim 24, wherein said means for generating optical feedback comprises distributed Bragg gratings.

31. The semiconductor laser of claim 24, wherein said means for spatially confining said photons comprises total internal reflection.

32. The semiconductor laser of claim 24, wherein said means for spatially confining said photons comprises photonic band gaps.

33. The semiconductor laser of claim 24, wherein said means for spatially confining said photons comprises diffraction confinement.

34. The semiconductor laser of claim 24, wherein said means for spatially confining said photons comprises gain confinement.

35. The semiconductor laser of claim 24, wherein said means for spatially confining said photons comprises Fresnel Refraction confinement.

36. A semiconductor laser, comprising:
a first photon propagating material having a first index of refraction (n1) and having a pinch disposed therein, said pinch having a second index of refraction (n1′);
a second photon propagating material disposed below said first photon propagating material and said second photon propagating material having a target region disposed therein and said target region having a third index of refraction (n2); and
a photon source for supplying photons to said first photon propagating material, said photon source disposed in said second photon propagating material; wherein
n1′<n1, n1′<n2, and said pinch redirects at least a portion of said photons from said first photon propagating material to said second photon propagating material in at least said photon source.

37. The semiconductor laser of claim 36, wherein said photon source is a quantum well.

38. The semiconductor laser of claim 36, wherein said target region contains a photo detector.

39. The semiconductor laser of claim 36, wherein said waveguide is clad in a material having a lower index of refraction than n1.

40. The semiconductor laser of claim 39, wherein said first propagating material is clad in glass

41. The semiconductor laser of claim 36, wherein said pinch is a squared pinch.

42. The semiconductor laser of claim 36, wherein said pinch is a curved pinch

43. The semiconductor laser of claim 36, wherein said pinch is an angled pinch.

44. The optical apparatus of claim 36, wherein said pinch is an irregular pinch.

45. The semiconductor laser of claim 36, wherein said pinch is an offset pinch.

46. The semiconductor laser of claim 36, wherein said pinch is a one-sided pinch.

47. The semiconductor laser of claim 36, further comprising at least one other pinch.

48. The semiconductor laser of claim 36, wherein said pinch allows photons to pass said pinch in an axial direction and propagate in said waveguide at a level that is at or below a threshold amount required to stimulate a laser to lase downstream of said pinch.
